(19) United States
(12) Patent Application Publication
(10) Pub. No.: US 2013/0159022 A1
(43) Pub. Date: Jun. 20, 2013

(54) CLINICAL STATE TIMELINE

(71) Applicants: Alexander Adrianus Martinus Verbeek, Den Bosch (NL); Roel Truyen, Turnhout (BE)

(72) Inventors: Alexander Adrianus Martinus Verbeek, Den Bosch (NL); Roel Truyen, Turnhout (BE)

(73) Assignee: KONINKLIJKE PHILIPS ELECTRONICS N.V., EINDHOVEN (NL)

(21) Appl. No.: 13/818,992

(22) PCT Filed: Sep. 2, 2011
(86) PCT No.: PCT/IB11/53842

§ 371 Date: Feb. 26, 2013

Related U.S. Application Data
(60) Provisional application No. 61/380,436, filed on Sep. 7, 2010.

(51) Int. Cl. G06F 19/00; G06Q 50/22

(52) U.S. Cl. CPC G06F 19/322; G06Q 50/22
USPC 705/3

(57) ABSTRACT

A method includes retrieving information indicative of patient care received by a patient during a plurality of phases of a patient care cycle for the patient, retrieving patterns of suggested care for the different phases of the patient care cycle, correlating the information indicative of patient care with the phases based on the patterns, extracting key disease descriptors from the information based on the correlation; and generating a signal indicative of the extracted key disease descriptors.

The following generally relates to clinical informatics and more particularly to presenting state and optionally event information on a timeline and is described with particular application to healthcare such as presenting disease state and patient care received as a function of phase for a patient care cycle that includes one or more phases; however, the following also relates to non-healthcare application.

Health care providers make multiple patient management decisions, such as treatment choices or diagnostic tests, based on a multitude of prior collected patient information, including patient medical history, family history, physical examinations, diagnostic tests and response of early treatment. In order to make such a decision, health care providers use a lot of prior medical knowledge that comes from implicit sources such as their medical training and experience and explicit sources such as results of medical research and clinical trials, and global or local clinical practice guidelines, which tend to evolve rapidly.

The basis of any clinical decision is the patient disease progression and current state, which is typically characterized by key disease descriptors (KDDs) that are collected from multiple tests and exams (e.g. the stage of a cancer) or from results of interventions and treatments (e.g. the margins of a resected tumor or the decrease of tumor size). KDDs have been distributed in the many single source documents and are stored electronically in patient care information systems (e.g. the electronic patient record), which provide the physician with quick electronic access to the information.

Decision making also requires medical knowledge, which is often documented in clinical practice guidelines. In these guidelines, disease specific medical and clinical knowledge collected from multiple clinical trials are combined into standards of care for each of the subsequent phases of a care cycle of a patient (e.g. screening, diagnoses, clinical staging, pretreatment evaluation, treatment, treatment monitoring etc.). Such guidelines recommend tests and treatment for a phase of the patient's care cycle.

Retrospectively, the clinical meaning of a KDD depends on the phase of the care cycle during which the KDD was collected. For example during surveillance phase of the care cycle a KDD may have a different impact on clinical decision making than the same KDD during the clinical staging phase of the care cycle. Unfortunately, in routine clinical practice this care cycle phase context has not been explicitly documented in patient care records.

Furthermore, patient care information systems generally do not provide a comprehensive integrated view of the patient disease progression together with the past care the patient received. Consequently, a clinician has to sift through a large collection of electronic documents to get an impression of a patient's disease and past care. This can be a time consuming and elaborate task. Moreover, it requires a physician to interpret the patient information, which relies on a physician's medical background knowledge.

Aspects of the present application address the above-referenced matters, and others.

According to one aspect, a method includes retrieving information indicative of patient care received by a patient during a plurality of phases of a patient care cycle for the patient, retrieving patterns of suggested care for the different phases of the patient care cycle, correlating the information indicative of patient care with the phases based on the patterns, extracting key disease descriptors from the information based on the correlation; and generating a signal indicative of the extracted key disease descriptors.

According to another aspect, a system includes a processor that generates a signal representing a timeline indicative of key disease descriptors for a patient as a function of a patient care cycle for the patient.

According to another aspect, a computer readable storage medium encoded with instructions which, when executed by a processor of a computer, cause the processor to: generate and present a timeline showing state information and completed event information for an execution cycle as a function of a plurality of phases of the execution cycle.

The invention may take form in various components and arrangements of components, and in various steps and arrangements of steps. The drawings are only for purposes of illustrating the preferred embodiments and are not to be construed as limiting the invention.

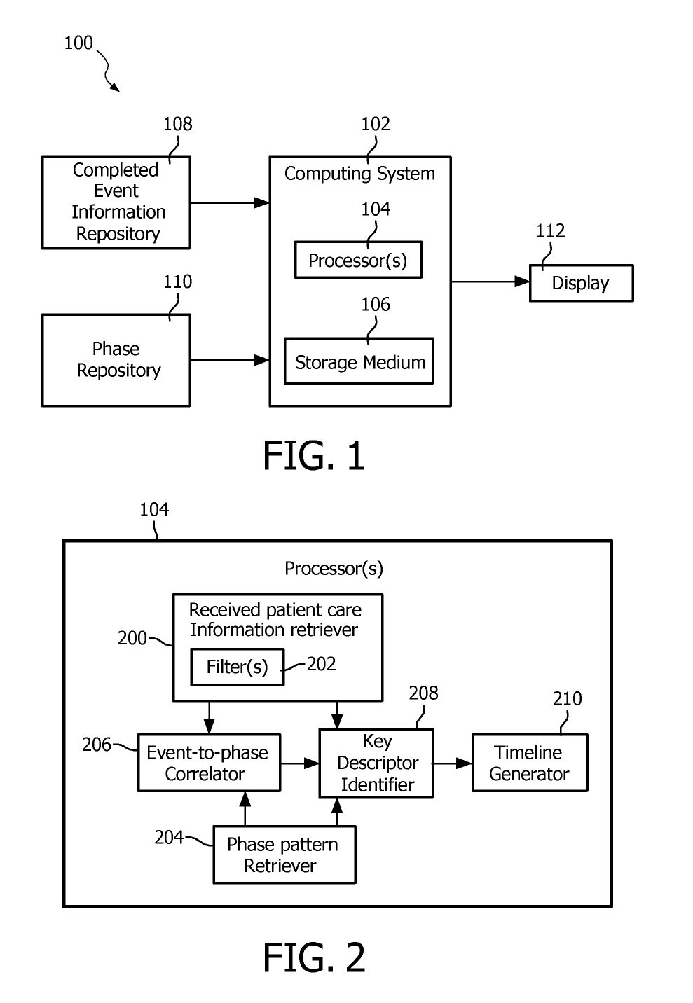

FIG. 1 illustrates an example system including a computing system for generating and displaying timelines.

FIG. 2 illustrates a non-limiting example of the one or more processors of the computing system running instructions for a healthcare application.

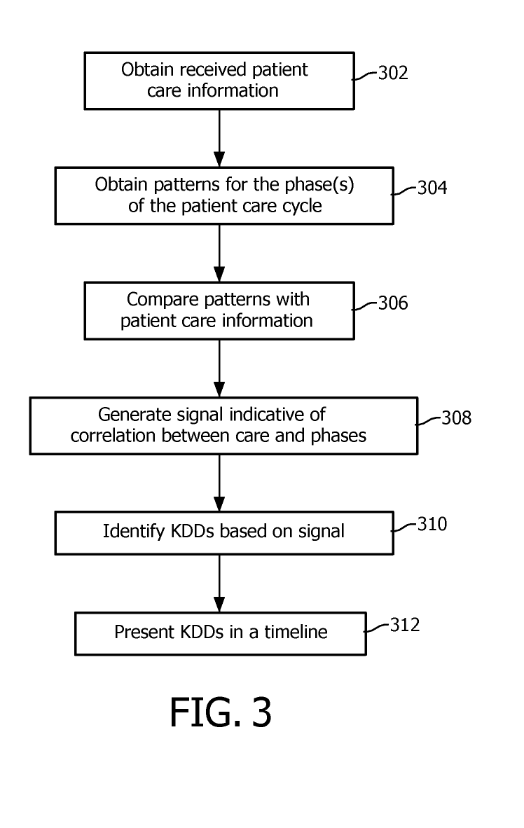

FIG. 3 illustrates an example method for generating and presenting the timeline.

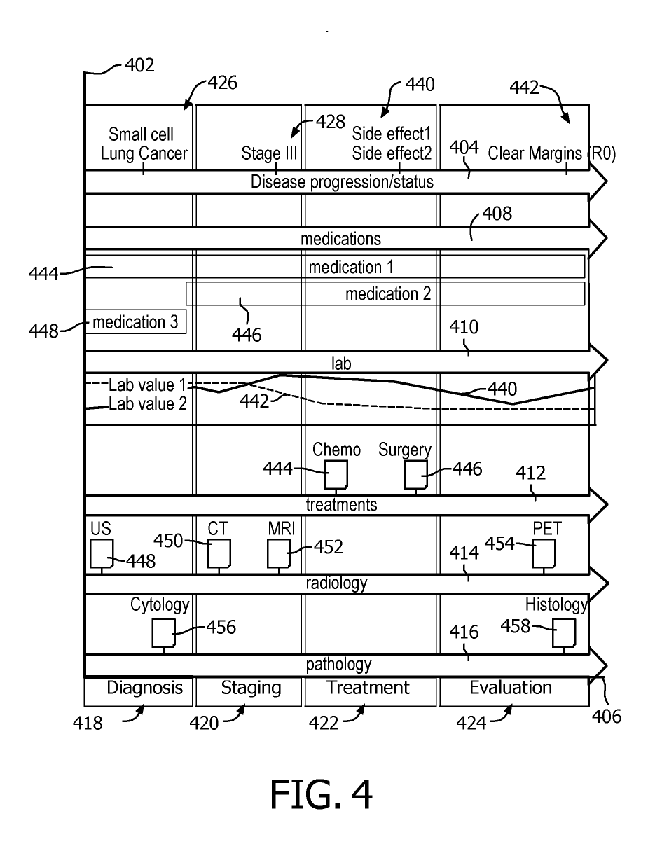

FIG. 4 illustrates a non-limiting example timeline.

FIG. 1 illustrates an example system 100 for generating a signal indicative and/or visualizing state (and optionally completed event) information in connection with a multiple phase execution cycle.

The system 100 includes a computing system 102 with one or more processors 104 and computer readable storage medium 106 encoded with computer readable instructions, which, when executed by the one or more processors 104 cause the system 102 to correlate state and, optionally, completed event information with the multiple phase execution cycle. As described in greater detail below, this correlation may be presented via a timeline in which the state and optionally completed event information is presented as a function of the cycle or the phases of the execution cycle.

A completed event information repository 108 stores electronic information indicative of the completed events, such as the completed event information employed by the computing system 102. The repository 108 may include various physical storage medium such as one or more databases, servers, hard drives, or the like. Furthermore, the repository 106 may be local to or remote from the system 100 and/or distributed amongst a plurality of systems. The completed event information repository 108 may also include portable storage medium such as external hard drives, CDs, DVDs, memory sticks, or the like.

A phase information repository 110 stores electronic information indicative of suggested events for the phases of the execution cycle and the different phases of the multiple phase execution cycle. Similar to the repository 108, the repository 110 may include various physical storage medium such as one or more databases, servers, hard drives, or the like. Furthermore, the repository 110 may be local to or remote from the system 100 and/or distributed amongst a plurality of systems. The phase information repository 108 may also include portable storage medium such as external hard drives, CDs, DVDs, memory sticks, or the like.

A display 112 such as a monitor or the like can be used to display at least the timeline. In one instance, the timeline is presented in a graphical user interface (GUI) of a window presented via the display 112. As utilized herein, a window is a visualization area or region of the GUI that presents (or visually outputs) information and/or accepts input or information. One or more windows can be superimposed over, graphically placed behind, and/or move around (e.g., via mouse or the like) in connection with one or more other windows. Such windows may be independent or dependent upon another window.

FIG. 2 illustrates an example of the one or more processors 104 running instructions for a healthcare application. As noted above, healthcare is but one non-limiting application and other applications are also contemplated herein.

A received patient care information retriever 200 identifies and retrieves information indicative of the patient care received for a patient from the electronic information stored in the event information repository 108. The illustrated received patient care information retriever 200 includes one or more filters 202 that facilitate extracting information from the repository 108 related to a disease or state of interest of the patient, which may be identified by a clinician and/or inferred by recent texts, procedures, etc. for the patient. This may facilitate reducing the volume of information subsequently processed by the one or more processors 104.

In this example, the repository 108 includes electronic information indicative of tests, exams, treatment, etc. performed on the patient during a patient care cycle for the patient. Such information may be from one or more of hospital information system (HIS), electronic medical record (EMR), radiology information system (RIS), etc. and/or one or more other systems, and include the clinical history of patients (e.g., body location(s), symptoms, signs, reason(s) for the exam, prior knowledge, etc.) and/or the findings, relevant anatomy locations and/or conclusions with current diagnosis for the patient. Such information may be included in a structured format (e.g., an electronic form) and/or less structured electronic documents containing free text.

A phase pattern retriever 204 identifies and retrieves, based on a care cycle for the patient, one or more patterns of suggested events to perform for one or more phases of the care cycle from the electronic information stored in the electronic state and phase information repository 110. Such information may be from electronic clinical guidelines, which document one or more sets of recommendations for healthcare professionals on how to treat and manage patients with specific diseases and/or conditions. Suitable guideline may be directed towards, but are not limited to, cancer, trauma, myocardial infarction, coronary heart failure, chest pain, asthma, atrial fibrillation, burns, diabetes, drug overdose, earache, gastrointestinal, and/or other clinical guidelines. Guidelines may be specific to a single subject and/or apply to a group of subjects.

An optional event-to-phase correlator 206 correlates or maps the retrieved patient care to the phases of the patient care cycle based on the retrieved phase patterns. The event-to-phase correlator 206 generates a signal indicative of the correlation. Since the actual care received by the patient during a phase may deviate from the guideline recommended care for a phase, the correlation may be based on a best possible fit such as on a highest probability, likelihood, confidence level, etc.

A key descriptor identifier 208 identifies one or more key disease descriptors (KDDs), which are indicative of a state and/or progression of a disease, for the care cycle, based on the patterns and/or the correlation. Again, KDDs are collected from multiple tests and exams or from results of interventions and treatments, and may has different meaning depending upon the phase in which it was determined. In this example, the KDDs are stored in electronic files stored in a KDD repository, which can be substantially similar to the repositories 108 and 110. For non-healthcare applications, the key descriptor identifier 208 identifies one or more key descriptors (KDs).

A timeline generator 210 generates a signal indicative of a timeline of the KDDs (and optionally the retrieved patient care). The timeline can be a function of the care cycle or the phases of the care cycle based on the retrieved care information, the retrieved phase pattern, the correlation between care and phases, the identified key descriptors and/or other information. In one non-limiting instance, the timeline characterizes and contextualizes a KDD(s), test(s), exam(s), treatment(s), etc. by presenting it as a function of phase, which provides a comprehensive integrated view. Since the clinical meaning of a KDD depends on the phase of the care cycle during which the KDD was collected (and the same KDD may show up in different phases), the timeline can be used in interpreting the meaning of the KDDs and subsequently using the interpretation to make a clinical decision.

FIG. 3 illustrates an example method for generating and presenting a state timeline. For sake of brevity and explanatory purposes, this method is described in connection with a healthcare application. However, the method is no limited to healthcare applications. Furthermore, it is to be appreciated that the ordering of the following acts is not limiting. As such, other orderings are contemplated herein. In addition, one or more acts may be omitted and/or one or more additional acts may be included.

At 302, electronic information indicative of actual care a patient received is obtained. As discussed above, one or more filters can be employed to extract only the care relevant to a disease or state of interest of the patient. Non limiting examples of such care, but are not limited to, exams, tests, treatments, etc. The electronic information can be obtained from one or more electronic repositories including, but not limited to, a hospital information system

(HIS), a radiology information system (RIS), an electronic medical record (EMR), a general practice information system, specialty specific information systems (e.g., cardiology, oncology, etc. information systems), and/or other source of patient information. Data interoperability protocols such as HL7 and/or other protocol can be used to obtain the information from the various different sources of information.

At 304, patterns of suggested care for one or more phases of care cycle are obtained. Non limiting examples of such phases include, but are not limited to, diagnosis, staging, pre-treatment evaluation, etc. The patterns can be obtained from electronic clinical practice guidelines and/or other sources. Clinical practice guidelines typically are organized in a tree like structure, and, as a result, the pattern of care recommended for a phase in the care cycle depends on prior established disease characteristics. For example, the patterns of care for the pre-treatment evaluation phase in a lung cancer guideline may slightly differ between stage I and stage II, for example, where the pattern for Stage II additionally recommends a Brain MRI.

At 306, the patterns are compared with the electronic information. By way of non-limiting example, for the pre-treatment evaluation phase and a lung cancer guideline, the pattern may include a combination of PFTs, a bronchoscopy, a mediastinocopy and a PET/CT scan, and the combination is compared to the actual care the patient received.

At 308, optionally, a signal indicative of a correlation between the care and the phases is generated based on the comparison. As noted above, since the actual care received by the patient during a phase can deviate from the guideline recommended care for that phase, the mapping may be based on a best possible fit such as on a highest probability, likelihood, confidence level, etc.

At 310, KDDs are identified in electronic information based on the signal and/or the patterns. Where the electronic information may include free text, natural language processing and the like can be used to facilitate determining and/or retrieving such data. By way of non-limiting example, in one instance information indicating that the mediastinal nodes where positive or negative is identified in the electronic reports from the PFTs, bronchoscopy, mediastinoscopy.

At 312, the KDDs (and optionally indicia indicative of the patient care received) are presented in a timeline as a function of the care cycle or the phases of the patient care cycle. In one instance, the timeline provides an integrated contextualized timeline view of disease progression and patient care, which can help a physician to quickly get a comprehensive overview of the past medical history of a patient. Alternatively, a signal is generated indicative of the KDDs and optionally the completed patient care as a function of the care cycle or the phases of the patient care cycle.

Such a timeline can provide a physician not yet familiar with a patient and/or under time critical conditions a relatively quick understanding of the condition of the patient. A non-limiting example of such a situation is a tumor board meeting where physicians of different disciplines in a time frame of several minutes need to obtain a shared view on a patient past care and medical condition and make a decision. FIG. 4 shows an example timeline for the tumor board meeting.

For this example, prior knowledge is stored in an electronic and computer interpretable form. A simple example of such knowledge is a rule set, which includes a condition and required information under that condition. The condition can include patient demographics (age, gender), history (previous cancers, previous surgeries etc), disease type and stage (type of cancer, location, TNM stage), treatments done (surgery, chemotherapy, radiation therapy) etc. Given such conditions, the rule specifies the relation between care phases, the typical test, exams and treatments that belong to such a phase and the key outcome parameters that characterize the disease and guide the next step in the care cycle.

In FIG. 4, a y-axis 402 represents a disease state 404 and actual care received by the patient and an x-axis 406 represents the phases of the patient care cycle. In this example, the care received includes medications taken 408, lab results 410, treatments 412, radiology procedures 414, and pathology 416, and the patient care cycle includes a diagnosis phase 418, a staging phase 420, a treatment phase 422 and a treatment evaluation phase 424. Other state, care, and/or phases can additionally or alternatively be included.

As shown in FIG. 4, identified KDDs 426, 428, 440 and 442 of the disease state 404 are respectively graphically mapped to the phases 418, 420, 422 and 424 of the cycle 406; medications 444, 446 and 448 are respectively graphically mapped to the phases 418-424, 418-424 and 414; lab results 440 and 442 are respectively graphically mapped to the phases 418-424 and 418-424; treatments 444 and 446 are respectively graphically mapped to the phase 422 and 422; radiology procedures 448, 450, 452 and 454 are respectively graphically mapped to the phases 418, 420, 420, and 424; and pathology 456 and 458 are respectively graphically mapped to the phases 418 and 424.

As discussed herein, such a the timeline provides an integrated contextualized timeline view of disease progression through the patient care cycle, which can help a physician to quickly get a comprehensive overview of the past medical history of a patient.

Alternatively, one or more of the state 404 or the actual care received by the patient (e.g., 408-416) is not presented or omitted from the timeline. Additionally or alternatively, the different phases (e.g., 418-424) are not presented or omitted from the timeline. In a variation, other information may additionally or alternatively be presented in the timeline. The state 404, care 408-416, phases 418-424, and/or other information be also be presented in one or more other timelines or otherwise presented.

One or more of the indicia presented in the timeline may provide a link to the information it represents such as through a hyperlink or other link. The may allow a clinician viewing the timeline the ability to click on the indicia via a mouse or otherwise select indicia to bring up further information such as test results, finding, images, etc. For example, clicking on the surgery tab 446 may bring up one or more electronic documents discussing the basis for and/or the findings from the surgery.

It is to be appreciated that the above can be employed in connection with a clinical decision support systems (CDSS). Generally, a CDSS is a computing system that facilitates decision-making in the clinical setting. Modern day CDSS have included interactive software-based systems that assist clinicians with clinical decisions. This has included presenting an interactive graphical user interface (GUI) that a user can interact with to help determine diagnosis, analysis, treatment, etc. of patient data.

CDSS have been based on clinical practice guidelines, which are documented sets of recommendations/suggestions for healthcare professionals on how to optimally treat and manage patients with specific diseases and conditions. The recommendations/suggestions are pieces of information (e.g., decision options and expected outcomes) to guide clinicians. With a CDSS, the clinician provides input, selects analysis options, etc., and the CDSS processes data and presents suggestions and/or analysis results. The clinician reviews the information and ultimately determines what is useful and makes clinical decisions. CDSS have been used pre-diagnoses, during diagnoses, and post diagnoses (including treatment planning).

The computing system 102 may be a workstation, a computer, or the like. Furthermore, the computing system 102 may be a standalone computing system or part of a network distributed across multiple healthcare provision sites. It is also to be appreciated that herein computer readable storage medium does not include signal medium. It is further to be appreciated that the embodiments herein can also be carried out using signal medium or a combination of storage and signal medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
retrieving information indicative of patient care received by a patient during a plurality of phases of a patient care cycle for the patient;
retrieving patterns of suggested care for the different phases of the patient care cycle;
correlating the information indicative of patient care with the phases based on the patterns;
extracting key disease descriptors from the information based on the correlation; and
generating a signal indicative of the extracted key disease descriptors.

2. The method of claim 1, further comprising:
generating and presenting a timeline indicative of the key disease descriptors as a function of the patient care cycle based on the signal.

3. The method of claim 3, wherein the timeline is indicative of the key disease descriptors as a function of the phases of the patient care cycle.

4. The method of claim 1, wherein the timeline further represents the patient care received by the patient as a function of the phase or the patient care cycle.

5. The method of claim 1, wherein the phases correspond to one or more of a diagnosis phase, a staging phase, or a pretreatment evaluation phase.

6. The method of claim 1, further comprising:
retrieving the patient care information from electronic data including information corresponding to at least one of a medical related exam, test or treatment performed on the patient.

7. The method of claim 1, wherein the information indicative of patient care is correlated with the phases based on a likelihood of the information belonging to the phases.

8. The method of claim 1, further comprising:
retrieving the key disease descriptors from electronic data that includes free text utilizing a natural language algorithm.

9. The method of claim 2, wherein the timeline is employed to determine a clinical decision for the patient.

10. The method of claim 1, wherein the patterns are obtained from clinical practice guidelines provided in electronic format.

11. The method of claim 2, wherein the timeline provides at least one of integrated contextualized information indicative of a progression of a disease of the patient over the cycle or a comprehensive overview of the medical history of the patient.

12. The method of claim 1, further comprising:
filtering data from a patient care repository based on a patient state of interest, wherein the retrieved information is retrieved from the filtered data.

13. A system, comprising:
a processor (104) that generates a signal representing a timeline indicative of key disease descriptors for a patient as a function of a patient care cycle for the patient.

14. The system of claim 13, wherein the timeline further represents a patient care received by the patient as a function of the patient care cycle.

15. The system of claim 14, further comprising:
a received patient care information retriever (202) that retrieves electronic information indicative of the patient care received by the patient;
a phase pattern retriever (204) that retrieves patterns of suggested care for the phases; and
an event-to-phase correlator (206) that generates a signal indicative of a correlation between the patient care received by the patient and the suggested care for the phases.

16. The system of claim 15, further comprising:
a key descriptor identifier (208) that identifies and retrieves key disease descriptors for the patient based on the correlation.

17. The system of claim 15, further comprising:
a timeline generator (210) that generates the timeline based on the key disease descriptors and the correlation.

18. The system of claim 16, wherein the timeline generator (210) further generates the timeline based on the electronic information indicative of the patient care received by the patient and the correlation.

19. The system of claim 13, wherein the timeline presents the information as a function of a plurality of phases of the cycle.

20. A computer readable storage medium encoded with computer executable instructions, which, when executed by a processor of a computer, cause the processor to:
generate and present a timeline showing state information and completed event information for an execution cycle as a function of a plurality of phases of the execution cycle.
